(19) United States
(12) Patent Application Publication
(10) Pub. No.: US 2023/0169323 A1
(43) Pub. Date: Jun. 1, 2023

(54) TRAINING A MACHINE LEARNING MODEL USING NOISILY LABELED DATA

(71) Applicant: International Business Machines Corporation, Armonk, NY (US)

(72) Inventors: Abhishek Kolagunda, San Jose, CA (US); Qinghan Xue, Sunnyvale, CA (US); Xiaolong Wang, Campbell, CA (US); Steven Nicholas Eliuk, San jose, CA (US)

(21) Appl. No.: 17/537,200

(22) Filed: Nov. 29, 2021

(51) Int. Cl. G06N 3/08

(52) U.S. Cl. CPC G06N 3/08

(57) ABSTRACT

A computer-implemented method, system and computer program product for training a machine learning model using noisily labeled data. A classification model is built in which a classified dataset is inputted, where the classified dataset includes label noise. Based on the input, the classification model generates a prediction of class probabilities. Furthermore, a second model is built with the same architecture as the classification model, where the second model is a moving average of the classification model, and where the second model generates a prediction of class probabilities. Weight factors used to weight such predictions of these models are generated by the artificial neural network (ANN), in which the weighted predictions are used by the ANN to obtain a prediction of class probabilities. The predictions of class probabilities of the ANN and the classification model are then combined to train the machine learning model.

### TECHNICAL FIELD

The present disclosure relates generally to deep learning, and more particularly to training a machine learning model (e.g., deep learning model) using noisily labeled data.

### BACKGROUND

Deep learning (also known as deep structured learning) is part of a broader family of machine learning methods based on artificial neural networks with representation learning. Learning can be supervised, semi-supervised or unsupervised.

Deep-learning architectures, such as deep neural networks, deep belief networks, deep reinforcement learning, recurrent neural networks and convolutional neural networks, have been applied to fields including computer vision, speech recognition, natural language processing, machine translation, bioinformatics, drug design, medical image analysis, material inspection and board game programs, where they have produced results comparable to and in some cases surpassing human expert performance.

### SUMMARY

In one embodiment of the present disclosure, a computer-implemented method for training a machine learning model using noisily labeled data comprises building a classification model that receives a classified dataset for which classes are pre-labeled as input, where the classified dataset comprises label noise, and where the classification model generates a prediction of class probabilities. The method further comprises building a second model with a same architecture as the classification model, where the second model is a moving average of the classification model, where the second model generates a prediction of class probabilities. Furthermore, the method comprises generating weight factors used to weight the predictions of class probabilities of the classification model and the second model by an artificial neural network. Additionally, the method comprises obtaining a prediction of class probabilities using the weighted predictions by the artificial neural network. In addition, the method comprises combining the predictions of class probabilities of the artificial neural network and the classification model to train the machine learning model.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the machine learning trainer to train machine learning models using noisily labeled data in accordance with an embodiment of the present disclosure;

FIG. 3 illustrates the interactions among the components of the models and neural network that are used in combination to train a machine learning model, such as a deep learning model, in accordance with an embodiment;

FIG. 4 illustrates an embodiment of the present disclosure of the hardware configuration of the machine learning trainer which is representative of a hardware environment for practicing the present disclosure; and

FIG. 5 is a flowchart of a method for training a machine learning model using noisily labeled data in accordance with an embodiment of the present disclosure.

### DETAILED DESCRIPTION

As stated in the Background section, deep learning (also known as deep structured learning) is part of a broader family of machine learning methods based on artificial neural networks with representation learning. Learning can be supervised, semi-supervised or unsupervised.

Deep-learning architectures, such as deep neural networks, deep belief networks, deep reinforcement learning, recurrent neural networks and convolutional neural networks, have been applied to fields including computer vision, speech recognition, natural language processing, machine translation, bioinformatics, drug design, medical image analysis, material inspection and board game programs, where they have produced results comparable to and in some cases surpassing human expert performance.

Recently, deep learning models are starting to be utilized in enterprise use cases. However, one of the challenges in utilizing deep learning in enterprise use cases is the quality of the annotated data. Annotated data of poor quality includes label noise, such as labeling mistakes from the annotator or computing errors from extraction algorithms. “Label noise,” as used herein, refers to mistakes, errors and/or meaningless data. Many studies have shown that label noise can significantly affect the accuracy of the learned classifiers.

As a result, deep neural networks in connection with enterprise data only work well when there is a large, well annotated training dataset. However, it is time consuming and expensive to collect such high-quality manual annotations. For instance, such high-quality manual annotations are expensive because the annotating requires domain expertise.

Consequently, in order to widely apply deep learning solutions to enterprise data, such deep learning models need to be trained to handle noisily labeled data.

The embodiments of the present disclosure provide a means for training a machine learning model, such as a deep learning model, using noisily labeled data.

In some embodiments of the present disclosure, the present disclosure comprises a computer-implemented method, system and computer program product for training a machine learning model using noisily labeled data. In one embodiment of the present disclosure, a classification model is built in which a classified dataset for which classes are pre-labeled is inputted to the classification model. In one embodiment, the classified dataset includes label noise. Based on the input, the classification model generates a prediction of class probabilities. Furthermore, a second model is built with the same architecture as the classification model, where the second model is a moving average of the classification model. Similarly, as the classification model, the second model generates a prediction of class probabilities. The predictions of class probabilities of the classification model and the second model are then combined using an artificial neural network. Weight factors used to weight the combined predictions of class probabilities of the classification model and the second model are generated by the artificial neural network. A prediction of class probabilities using these weighted predictions is then obtained by the artificial neural network. The predictions of class probabilities of the artificial neural network and the classification model are then combined to train the machine learning model, such as the deep learning model. In this manner, a machine learning model, such as a deep learning model, is trained using noisily labeled data.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

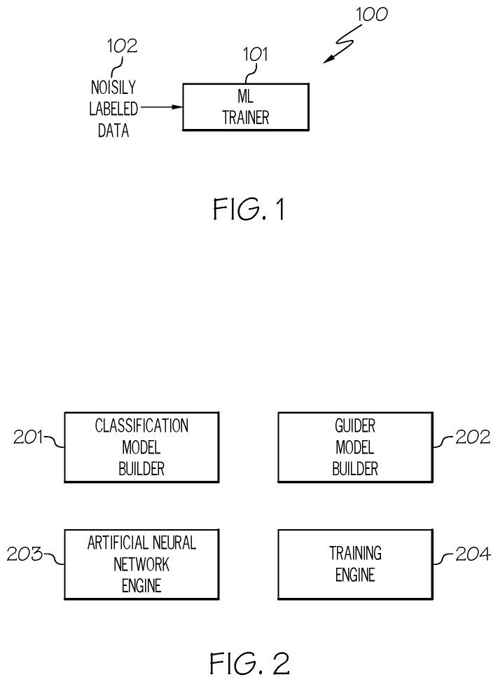

Referring now to the Figures in detail, FIG. 1 illustrates an embodiment of the present disclosure of a communication system 100 for practicing the principles of the present disclosure. Communication system 100 includes a machine learning (ML) trainer 101 configured to train machine learning models, such as deep learning models, using noisily labeled data 102.

“Noisily labeled data,” as used herein, refers to mistakes, errors and/or meaningless data. As discussed above, annotated data of poor quality includes label noise, such as labeling mistakes from the annotator or computing errors from extraction algorithms. Currently, such label noise prevents the training of machine learning models, such as deep learning models, to accurately make predictions or decisions. However, using the principles of the present disclosure, machine learning trainer 101 trains machine learning models, such as deep learning models, using noisily labeled data while still enabling accurate predictions or decisions by the machine learning model as discussed further below.

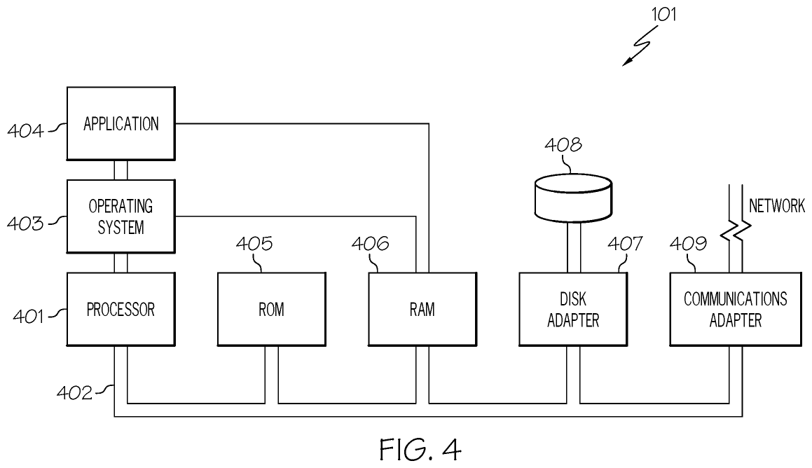

A description of the software components of machine learning trainer 101 used for training machine learning models using noisily labeled data is provided below in connection with FIG. 2. A description of the hardware configuration of machine learning trainer 101 is provided further below in connection with FIG. 4.

As stated above, FIG. 2 is a diagram of the software components used by machine learning trainer 101 (FIG. 1) to train machine learning models using noisily labeled data in accordance with an embodiment of the present disclosure.

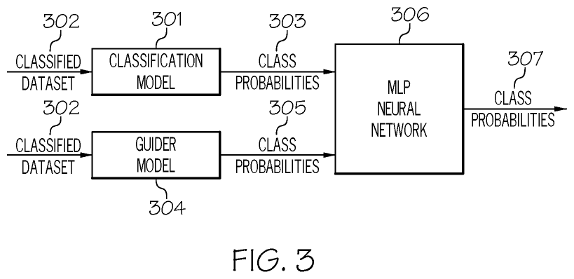

Referring to FIG. 2, in conjunction with FIG. 1, machine learning trainer 101 includes a classification model builder 201 configured to build a classification model, such as shown in FIG. 3.

FIG. 3 illustrates the interactions among the components of the models and neural network that are used in combination to train a machine learning model, such as a deep learning model, in accordance with an embodiment.

Referring to FIG. 3, classification model 301 receives an input of a classified dataset 302 (labeled training dataset) for which classes are pre-labeled. For example, a set of images of fruits may be classified in the classes of oranges, apples and pears.

In one embodiment, such a classified dataset includes label noise. As discussed above, “label noise,” as used herein, refers to mistakes, errors and/or meaningless data. In one embodiment, classification model 301 is trained using the labeled training dataset 302 as well as categorical cross entropy loss. “Categorical cross entry loss,” as used herein, refers to a loss function that is used in multi-class classification tasks. These are tasks where an example can only belong to one out of many possible categories, and the model must decide which one. In one embodiment, the softmax function (generalization of the logistic function to multiple dimensions) uses the categorical cross entropy loss to rescale the model output so that it has the correct properties.

In one embodiment, classification model 301 generates a prediction of class probabilities 303 based on such an input. For example, classification model 301 may classify different fruits and vegetables into 100 classes. “Class probabilities,” as used herein, refer to the probability distribution over such a set of classes (e.g., 100 classes) given an input.

Returning to FIG. 2, in conjunction with FIGS. 1 and 3, in one embodiment, classification model builder 201 builds classification model 301 by splitting the data into a training set and a testing set. In one embodiment, classification model builder 201 builds classification model 301 on the training set and checks the accuracy of the model by using it on the testing set. In one embodiment, classification model builder 201 may then build a classifier (e.g., random forest classifier) and fit the model to the data. The accuracy of the model may then be checked as to how accurate are the predictions against the actual test set values. In one embodiment, a confusion matrix is utilized to check the accuracy of classification model 301.

In one embodiment, classification model builder 201 utilizes a classification algorithm to build classification model 301. Examples of such classification algorithms include, but not limited to, linear classifiers (e.g., logistic regression, Naïve Bayes classifier), nearest neighbor, support vector machines, decision trees, boosted trees, random forest, and neural networks.

In one embodiment, classification model builder 201 applies pre-processing steps to the training and testing datasets separately in order to avoid data leakage. In one embodiment, one such pre-processing steep involves data normalization to create a dataset within the same scale. In another embodiment, one such pre-processing step involves recursive feature elimination to determine the most important features in the dataset when predicting the target variable.

Machine learning trainer 101 further includes a guider model builder 202 configured to build a model referred to herein as the “guider model 304,” such as shown in FIG. 3.

Referring to FIG. 3, in one embodiment, guider model 304 has the same architecture as classification model 301. In one embodiment, guider model 304 is a moving average of classification model 301. That is, the parameters of guider model 304 are updated as a moving average of classification model 301.

In one embodiment, guider model 304 receives classified dataset 302 as input (similarly as classification model 301) in which the classes are pre-labeled. Guider model 304 also generates a prediction of class probabilities 305 based on such an input. However, such an output differs from the output generated by classification model 301 due to the updating of the parameters as a moving average of classification model 301.

In one embodiment, such models form an “ensemble,” which is a combination of machine learning models (commonly referred to as “weak learners”). The results of which (predictions from classification and guider models 301, 304) are combined and inputted into a multilayer perceptron neural network (“MLP” neural network) (also referred to as the “ensemble network”) as discussed further below.

Returning to FIG. 2, in conjunction with FIGS. 1 and 3, in one embodiment, guider model builder 202 builds guider model 304 with the same architecture as classification model 301 as discussed above. In one embodiment, guider model builder 202 enables guider model 304 to be a moving average of classification model 301 utilizing a moving average algorithm. A “moving average,” as used herein, is a calculation to analyze data points by creating a series of averages of different subsets of the full dataset. Given a series of parameters of classification model 301 and a fixed subset size, the first element of the moving average is obtained by taking the average of the initial fixed subset of the series of parameters. Then the subset is modified by “shifting forward.” That is, the subset is modified by excluding the first parameter of the series and including the next value in the subset. Guider model builder 202 uses various moving average algorithms for updating the parameters of guider model 304 as a moving average of classification model 301, such as simple moving average, cumulative moving average, weighted moving average, and exponential moving average.

Machine learning trainer 101 further includes an artificial neural network engine 203 configured to combine the predictions of class probabilities 303, 305 of classification model 301 and guider model 304, respectively, using an artificial neural network, such as a multilayer perceptron (“MLP”) neural network 306 as shown in FIG. 3.

Referring to FIG. 3, MLP neural network 306 receives as input, the combination of the predictions of the class probabilities 303, 305 from classification model 301 and guider model 304, respectively. In one embodiment, MLP neural network 306 includes at least three layers of nodes: an input layer, a hidden layer and an output layer. In one embodiment, except for the input nodes, each node is a neuron that uses a nonlinear activation function. In one embodiment, artificial neural network engine 203 utilizes a supervised learning technique (e.g., backpropagation) for training MLP neural network 306.

In one embodiment, MLP neural network 306 has a linear activation function in all neurons, such as a sigmoid function.

As discussed above, in one embodiment, MLP neural network 306 consists of three or more layers, such as three or more layers of nonlinearly-activating nodes. Since MLPs are fully connected, each node in one layer connects with a certain weight to every node in the following layer.

In one embodiment, learning occurs in the perceptron (linear classifier) by changing connection weights after each piece of data is processed based on the amount of error in the output compared to the expected result. In one embodiment, MLP neural network 306 consists of perceptrons that are organized into layers. In one embodiment, such perceptrons employ arbitrary activation functions. That is, the MLP neuron is free to either perform classification or regression, depending upon its activation function.

Furthermore, in one embodiment, MLP neural network 306 is configured to generate weight factors from the predictions of the class probabilities 303, 305, which are used to weight the predictions 303, 305 of classification model 301 and guider model 304, respectively.

Weight is the parameter within a neural network that transforms input data within the network's hidden layers. As discussed above, a neural network is a series of nodes or neurons. Within each node is a set of inputs, weight, and a bias value. As an input enters the node, it gets multiplied by a weight value and the resulting output is either observed, or passed to the next layer in the neural network. Often the weights of a neural network are contained within the hidden lavers of the network.

Within a neural network, there is an input layer, that takes the input signals and passes them to the next layer. Next, the neural network contains a series of hidden layers which apply transformations to the input data. It is within the nodes of the hidden layers that the weights are applied. For example, a single node may take the input data and multiply it by an assigned weight value, then add a bias before passing the data to the next layer. The final layer of the neural network is also known as the output layer. The output layer often tunes the inputs from the hidden layers to produce the desired numbers in a specified range.

Weights are learnable parameters inside the network. A teachable neural network will randomize the weight values before learning initially begins. As training continues, the learnable parameters (weights) are adjusted toward the desired values and the correct output. Weights indicate the strength of the connection between the input and output. Weight affects the amount of influence a change in the input will have upon the output. A low weight value will have no change on the input, and alternatively, a larger weight value will more significantly change the output.

In one embodiment, when a neural network is trained on the training set, it is initialized with a set of weights. These weights are then optimized during the training period and the optimum weights (weight factors or weight values) are produced.

As discussed above, the generated weight factors from the predictions of the class probabilities 303, 305, are used to weight the predictions 303, 305 of classification model 301 and guider model 304, respectively.

The weighted predictions are then passed through a fully connected layer of MLP neural network 306 to obtain a prediction of class probabilities 307.

Returning to FIG. 2, in conjunction with FIGS. 1 and 3, machine learning trainer 101 additionally includes a training engine 204 configured to train a machine learning model, such as a deep learning model. In one embodiment, training engine 204 combines the output of MLP neural network 306 (prediction of class probabilities 307) and the output of classification model 301 (prediction of class probabilities 303) as a log sum (i.e., sum of the logarithms) of corresponding class probabilities using a residual connection, which is used to train a machine learning model, such as a deep learning model. A “residual connection,” as used herein, is used to allow gradients to flow through MLP neural network 306 directly without passing through non-linear activation functions.

In one embodiment, training engine 204 combines the predictions of class probabilities 303, 307 by summing the probabilities for each class and passing the predicted values through a softmax function. In one embodiment, such scores are normalized, such that probabilities across the class labels sum to 1.0.

As discussed above, in one embodiment, classification model 301 is trained using a categorical cross entropy loss. Such a categorical cross entry loss may be said to correspond to the objective to optimize in order to train the machine learning model. In one embodiment, the categorical cross entry loss corresponds to a distance between ground truth labels and the combined predictions of class probabilities 303, 307 of classification model 301 and MLP neural network 306, respectively. “Ground truth,” as used herein, refers to the accuracy of the training set's classification for supervised learning techniques. That is, the “ground truth label” refers to the correct class probabilities (probability distribution over such a set of classes) that is labeled or identified by an expert. Such ground truth labels may be stored in a storage device (e.g., memory, disk unit) of machine learning trainer 101. In one embodiment, training engine 204 determines such a distance by determining the Euclidean distance or cosine similarity using algorithms, such as k-nearest neighbors algorithm, uniform manifold approximation and projection, hierarchical density-based spatial clustering of applications with noise, etc.

In one embodiment, the categorical cross entry loss corresponds to a distance between the prediction of class probabilities 305 of guider model 304 and the combined predictions of class probabilities 303, 307 of classification model 301 and MLP neural network 306, respectively. That is, training engine 204 determines the categorical cross entry loss by determining the distance (e.g., Euclidean distance, cosine similarity) between the prediction of class probabilities 305 of guider model 304 and the combined predictions of class probabilities 303, 307 of classification model 301 and MLP neural network 306, respectively.

In one embodiment, the categorical cross entry loss corresponds to a sum of the top-k probability weighted log probabilities, where k is a positive integer number. As previously discussed, MLP neural network 306 generates weight factors from the predictions of the class probabilities 303, 305, which are used to weight the predictions 303, 305 of classification model 301 and guider model 304, respectively. Such weighted predictions correspond to the weighted log probabilities. The top-k of these weighted log probabilities are then summed by training engine 204 to correspond to the categorical cross entry loss.

As discussed above, the categorical cross entry loss corresponds to the objective to optimize in order to train the machine learning model. Such a machine learning model is trained by training both classification model 301 and ensemble network 306 end-to-end using the objective.

A further description of these and other functions is provided below in connection with the discussion of the method for training a machine learning model using noisily labeled data.

Prior to the discussion of the method for training a machine learning model using noisily labeled data, a description of the hardware configuration of machine learning trainer 101 (FIG. 1) is provided below in connection with FIG. 4.

Referring now to FIG. 4, FIG. 4 illustrates an embodiment of the present disclosure of the hardware configuration of machine learning trainer 101 (FIG. 1) which is representative of a hardware environment for practicing the present disclosure.

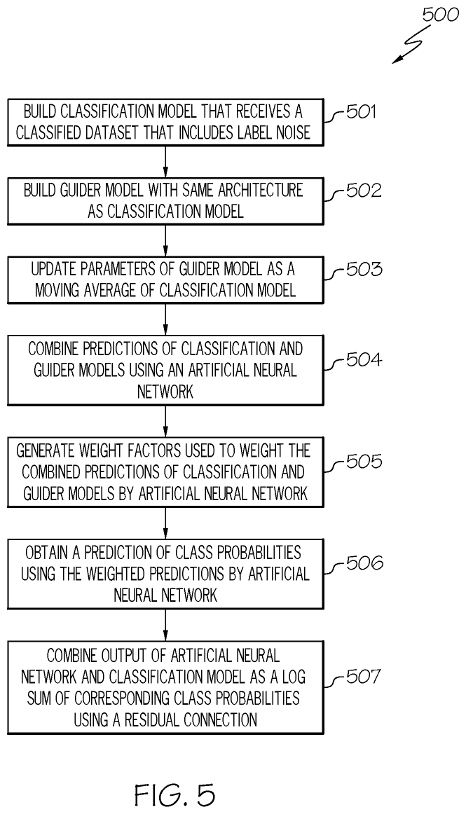

Machine learning trainer 101 has a processor 401 connected to various other components by system bus 402. An operating system 403 runs on processor 401 and provides control and coordinates the functions of the various components of FIG. 4. An application 404 in accordance with the principles of the present disclosure runs in conjunction with operating system 403 and provides calls to operating system 403 where the calls implement the various functions or services to be performed by application 404. Application 404 may include, for example, classification model builder 201 (FIG. 2), guider model builder 202 (FIG. 2), artificial neural network engine 203 (FIG. 2) and training engine 204 (FIG. 2). Furthermore, application 404 may include, for example, a program for training a machine learning model using noisily labeled data as discussed further below in connection with FIG. 5.

Referring again to FIG. 4, read-only memory (“ROM”) 405 is connected to system bus 402 and includes a basic input/output system (“BIOS”) that controls certain basic functions of machine learning trainer 101. Random access memory (“RAM”) 406 and disk adapter 407 are also connected to system bus 402. It should be noted that software components including operating system 403 and application 404 may be loaded into RAM 406, which may be machine learning trainer's 101 main memory for execution. Disk adapter 407 may be an integrated drive electronics (“IDE”) adapter that communicates with a disk unit 408, e.g., disk drive. It is noted that the program for training a machine learning model using noisily labeled data, as discussed further below in connection with FIG. 5, may reside in disk unit 408 or in application 404.

Machine learning trainer 101 may further include a communications adapter 409 connected to bus 402. Communications adapter 409 interconnects bus 402 with an outside network to communicate with other devices.

In one embodiment, application 404 of machine learning trainer 101 includes the software components of classification model builder 201, guider model builder 202, artificial neural network engine 203 and training engine 204. In one embodiment, such components may be implemented in hardware, where such hardware components would be connected to bus 402. The functions discussed above performed by such components are not generic computer functions. As a result, machine learning trainer 101 is a particular machine that is the result of implementing specific, non-generic computer functions.

In one embodiment, the functionality of such software components (e.g., classification model builder 201, guider model builder 202, artificial neural network engine 203 and training engine 204) of machine learning trainer 101, including the functionality for training a machine learning model using noisily labeled data, may be embodied in an application specific integrated circuit.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated above, deep-learning architectures, such as deep neural networks, deep belief networks, deep reinforcement learning, recurrent neural networks and convolutional neural networks, have been applied to fields including computer vision, speech recognition, natural language processing, machine translation, bioinformatics, drug design, medical image analysis, material inspection and board game programs, where they have produced results comparable to and in some cases surpassing human expert performance. Recently, deep learning models are starting to be utilized in enterprise use cases. However, one of the challenges in utilizing deep learning in enterprise use cases is the quality of the annotated data. Annotated data of poor quality includes label noise, such as labeling mistakes from the annotator or computing errors from extraction algorithms. “Label noise,” as used herein, refers to mistakes, errors and/or meaningless data. Many studies have shown that label noise can significantly affect the accuracy of the learned classifiers. As a result, deep neural networks in connection with enterprise data only work well when there is a large, well annotated training dataset. However, it is time consuming and expensive to collect such high-quality manual annotations. For instance, such high-quality manual annotations are expensive because the annotating requires domain expertise. Consequently, in order to widely apply deep learning solutions to enterprise data, such deep learning models need to be trained to handle noisily labeled data.

The embodiments of the present disclosure provide a means for training a machine learning model, such as a deep learning model, using noisily labeled data as discussed below in connection with FIG. 5.

FIG. 5 is a flowchart of a method 500 for training a machine learning model (e.g., deep learning model) using noisily labeled data in accordance with an embodiment of the present disclosure.

Referring to FIG. 5, in conjunction with FIGS. 1-4, in step 501, classification model builder 201 of machine learning trainer 101 builds classification model 301, which receives a classified dataset 302 (labeled training dataset) as input that includes label noise.

As discussed above, in one embodiment, classification model 301 receives an input of a classified dataset 302 for which classes are pre-labeled. For example, a set of images of fruits may be classified in the classes of oranges, apples and pears.

In one embodiment, such a classified dataset includes label noise. As discussed above, “label noise,” as used herein, refers to mistakes, errors and/or meaningless data. Furthermore, as discussed above, classification model 301 is trained using classified dataset 302 and a categorical cross entropy loss. “Categorical cross entry loss,” as used herein, refers to a loss function that is used in multi-class classification tasks. These are tasks where an example can only belong to one out of many possible categories, and the model must decide which one. In one embodiment, the softmax function (generalization of the logistic function to multiple dimensions) uses the categorical cross entropy loss to rescale the model output so that it has the correct properties.

In one embodiment, classification model 301 generates a prediction of class probabilities 303 based on such an input. For example, classification model 301 may classify different fruits and vegetables into 100 classes. “Class probabilities,” as used herein, refer to the probability distribution over such a set of classes (e.g., 100 classes) given an input.

Furthermore, in one embodiment, classification model builder 201 builds classification model 301 by splitting the data into a training set and a testing set. In one embodiment, classification model builder 201 builds classification model 301 on the training set and checks the accuracy of the model by using it on the testing set. In one embodiment, classification model builder 201 may then build a classifier (e.g., random forest classifier) and fit the model to the data. The accuracy of the model may then be checked as to how accurate are the predictions against the actual test set values. In one embodiment, a confusion matrix is utilized to check the accuracy of classification model 301.

In one embodiment, classification model builder 201 utilizes a classification algorithm to build classification model 301. Examples of such classification algorithms include, but not limited to, linear classifiers (e.g., logistic regression, Naïve Bayes classifier), nearest neighbor, support vector machines, decision trees, boosted trees, random forest, and neural networks.

In one embodiment, classification model builder 201 applies pre-processing steps to the training and testing datasets separately in order to avoid data leakage. In one embodiment, one such pre-processing steep involves data normalization to create a dataset within the same scale. In another embodiment, one such pre-processing step involves recursive feature elimination to determine the most important features in the dataset when predicting the target variable.

In step 502, guider model builder 202 of machine learning trainer 101 builds a guider model 304 with the same architecture as classification model 301.

As stated above, in one embodiment, guider model 304 is a moving average of classification model 301. That is, the parameters of guider model 304 are updated as a moving average of classification model 301.

In one embodiment, guider model 304 receives classified dataset 302 as input (similarly as classification model 301) in which the classes are pre-labeled. Guider model 304 also generates a prediction of class probabilities 305 based on such an input. However, such an output differs from the output generated by classification model 301 due to the updating of the parameters as a moving average of classification model 301.

In one embodiment, such models (classification model 301 and guider model 304) form an “ensemble,” which is a combination of machine learning models (commonly referred to as “weak learners”). The results of which (predictions from classification and guider models 301, 304) are combined and inputted into multilayer perceptron neural network 306 (“MLP” neural network) (also referred to as the “ensemble network”).

In step 503, guider model builder 202 of machine learning trainer 101 updates the parameters of guider model 304 as a moving average of classification model 301.

As discussed above, in one embodiment, guider model builder 202 enables guider model 304 to be a moving average of classification model 301 utilizing a moving average algorithm. A “moving average,” as used herein, is a calculation to analyze data points by creating a series of averages of different subsets of the full dataset. Given a series of parameters of classification model 301 and a fixed subset size, the first element of the moving average is obtained by taking the average of the initial fixed subset of the series of parameters. Then the subset is modified by “shifting forward.” That is, the subset is modified by excluding the first parameter of the series and including the next value in the subset. Guider model builder 202 uses various moving average algorithms for updating the parameters of guider model 304 as a moving average of classification model 301, such as simple moving average, cumulative moving average, weighted moving average, and exponential moving average.

In step 504, artificial neural network engine 203 of machine learning trainer 101 combines the predictions of classification and guider models 301, 304 using an artificial neural network, such as multilayer perceptron (MLP) neural network 306.

As stated above, MLP neural network 306 receives as input, the combination of the predictions of the class probabilities 303, 305 from classification model 301 and guider model 304, respectively. In one embodiment, MLP neural network 306 includes at least three layers of nodes: an input layer, a hidden layer and an output layer. In one embodiment, except for the input nodes, each node is a neuron that uses a nonlinear activation function. In one embodiment, artificial neural network engine 203 utilizes a supervised learning technique (e.g., backpropagation) for training MLP neural network 306.

In one embodiment, MLP neural network 306 has a linear activation function in all neurons, such as a sigmoid function.

Furthermore, in one embodiment, MLP neural network 306 consists of three or more layers, such as three or more layers of nonlinearly-activating nodes. Since MLPs are fully connected, each node in one layer connects with a certain weight to every node in the following layer.

In one embodiment, learning occurs in the perceptron by changing connection weights after each piece of data is processed based on the amount of error in the output compared to the expected result. In one embodiment, MLP neural network 306 consists of perceptrons that are organized into layers. In one embodiment, such perceptrons employ arbitrary activation functions. That is, the MLP neuron is free to either perform classification or regression, depending upon its activation function.

In step 505, artificial neural network engine 203 of machine learning trainer 101 generates weight factors used to weight the combined predictions of classification and guider models 301, 304 by the artificial neural network, such as MLP neural network 306.

As discussed above, in one embodiment, MLP neural network 306 is configured to generate weight factors (weight values) from the predictions of the class probabilities 303, 305, which are used to weight the predictions 303, 305 of classification model 301 and guider model 304, respectively.

Weight is the parameter within a neural network that transforms input data within the network's hidden layers. As discussed above, a neural network is a series of nodes or neurons. Within each node is a set of inputs, weight, and a bias value. As an input enters the node, it gets multiplied by a weight value and the resulting output is either observed, or passed to the next layer in the neural network. Often the weights of a neural network are contained within the hidden layers of the network.

Within a neural network, there is an input layer, that takes the input signals and passes them to the next layer. Next, the neural network contains a series of hidden layers which apply transformations to the input data. It is within the nodes of the hidden layers that the weights are applied. For example, a single node may take the input data and multiply it by an assigned weight value, then add a bias before passing the data to the next layer. The final layer of the neural network is also known as the output layer. The output layer often tunes the inputs from the hidden layers to produce the desired numbers in a specified range.

Weights are learnable parameters inside the network. A teachable neural network will randomize the weight values before learning initially begins. As training continues, the learnable parameters (weights) are adjusted toward the desired values and the correct output. Weights indicate the strength of the connection between the input and output. Weight affects the amount of influence a change in the input will have upon the output. A low weight value will have no change on the input, and alternatively, a larger weight value will more significantly change the output.

In one embodiment, when a neural network is trained on the training set, it is initialized with a set of weights. These weights are then optimized during the training period and the optimum weights (weight factors or weight values) are produced.

In step 506, artificial neural network engine 203 of machine learning trainer 101 obtains a prediction of class probabilities using the weighted predictions by the artificial neural network, such as MLP neural network 306.

As discussed above, the weighted predictions are then passed through a fully connected layer of MLP neural network 306 to obtain a prediction of class probabilities 307.

In step 507, training engine 204 of machine learning trainer 101 combines the output of artificial neural network, such as MLP neural network 306, and classification model 301 as a log sum of corresponding class probabilities using a residual connection, which is used to train a machine learning model, such as a deep learning model.

As stated above, in one embodiment, training engine 204 combines the output of MLP neural network 306 (prediction of class probabilities 307) and the output of classification model 301 (prediction of class probabilities 303) as a log sum (i.e., sum of the logarithms) of corresponding class probabilities using a residual connection, which is used to train a machine learning model, such as a deep learning model. A “residual connection,” as used herein, is used to allow gradients to flow through MLP neural network 306 directly without passing through non-linear activation functions.

In one embodiment, training engine 204 combines the predictions of class probabilities 303, 307 by summing the probabilities for each class and passing the predicted values through a softmax function. In one embodiment, such scores are normalized, such that probabilities across the class labels sum to 1.0.

Furthermore, as discussed above, classification model 301 is trained using a categorical entropy loss. Such a categorical cross entry loss may be said to correspond to the objective to optimize in order to train the machine learning model. In one embodiment, the categorical cross entry loss corresponds to a distance between ground truth labels and the prediction of class probabilities 303 of classification model 301. “Ground truth,” as used herein, refers to the accuracy of the training set's classification for supervised learning techniques. That is, the “ground truth label” refers to the correct class probabilities (probability distribution over such a set of classes) that is labeled or identified by an expert. Such ground truth labels may be stored in a storage device (e.g., memory 405, disk unit 408) of machine learning trainer 101. In one embodiment, training engine 204 determines such a distance by determining the Euclidean distance or cosine similarity using algorithms, such as k-nearest neighbors algorithm, uniform manifold approximation and projection, hierarchical density-based spatial clustering of applications with noise, etc.

In one embodiment, the categorical cross entry loss corresponds to a sum of the top-k probability weighted log probabilities, where k is a positive integer number. As previously discussed, MLP neural network 306 generates weight factors from the predictions of the class probabilities 303, 305, which are used to weight the predictions 303, 305 of classification model 301 and guider model 304, respectively. Such weighted predictions correspond to the weighted log probabilities. The top-k of these weighted log probabilities are then summed by training engine 204 to correspond to the categorical cross entry loss.

In one embodiment, the categorical cross entry loss corresponds to a distance between the ground truth labels and the log sum of the predictions of the classification and guider models 301, 304. That is, training engine 204 determines the categorical cross entry loss by determining the distance (e.g., Euclidean distance, cosine similarity) between the ground truth labels and the log sum (sum of the logarithms) of the class probabilities 303, 305 of classification model 301 and guider model 304, respectively.

As discussed above, the categorical cross entry loss corresponds to the objective to optimize in order to train the machine learning model. Such a machine learning model is trained by training both classification model 301 and ensemble network 306 end-to-end using the objective.

In this manner, the principles of the present disclosure provide the means for training a machine learning model, such as a deep learning model, using noisily labeled data.

Furthermore, the principles of the present disclosure improve the technology or technical field involving deep learning.

As discussed above, deep-learning architectures, such as deep neural networks, deep belief networks, deep reinforcement learning, recurrent neural networks and convolutional neural networks, have been applied to fields including computer vision, speech recognition, natural language processing, machine translation, bioinformatics, drug design, medical image analysis, material inspection and board game programs, where they have produced results comparable to and in some cases surpassing human expert performance. Recently, deep learning models are starting to be utilized in enterprise use cases. However, one of the challenges in utilizing deep learning in enterprise use cases is the quality of the annotated data. Annotated data of poor quality includes label noise, such as labeling mistakes from the annotator or computing errors from extraction algorithms. “Label noise,” as used herein, refers to mistakes, errors and/or meaningless data. Many studies have shown that label noise can significantly affect the accuracy of the learned classifiers. As a result, deep neural networks in connection with enterprise data only work well when there is a large, well annotated training dataset. However, it is time consuming and expensive to collect such high-quality manual annotations. For instance, such high-quality manual annotations are expensive because the annotating requires domain expertise. Consequently, in order to widely apply deep learning solutions to enterprise data, such deep learning models need to be trained to handle noisily labeled data.

Embodiments of the present disclosure improve such technology by building a classification model in which a classified dataset (labeled training dataset) for which classes are pre-labeled is inputted to the classification model. In one embodiment, the classified dataset includes label noise. Based on the input, the classification model generates a prediction of class probabilities. Furthermore, a second model is built with the same architecture as the classification model, where the second model is a moving average of the classification model. Similarly, as the classification model, the second model generates a prediction of class probabilities. The predictions of class probabilities of the classification model and the second model are then combined using an artificial neural network. Weight factors used to weight the combined predictions of class probabilities of the classification model and the second model are generated by the artificial neural network. A prediction of class probabilities using these weighted predictions is then obtained by the artificial neural network. The predictions of class probabilities of the artificial neural network and the classification model are then combined to train the machine learning model, such as the deep learning model. In this manner, a machine learning model, such as a deep learning model, is trained using noisily labeled data. Furthermore, in this manner, there is an improvement in the technical field involving deep learning.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for training a machine learning model using noisily labeled data, the method comprising:
building a classification model that receives a classified dataset for which classes are pre-labeled as input, wherein said classified dataset comprises label noise, wherein said classification model generates a prediction of class probabilities;
building a second model with a same architecture as said classification model, wherein said second model is a moving average of said classification model, wherein said second model generates a prediction of class probabilities;
generating weight factors used to weight said predictions of class probabilities of said classification model and said second model by an artificial neural network;
obtaining a prediction of class probabilities using said weighted predictions by said artificial neural network; and
combining said predictions of class probabilities of said artificial neural network and said classification model to train said machine learning model.

2. The method as recited in claim 1 further comprising:
updating parameters of said second model as said moving average of said classification model.

3. The method as recited in claim 1 further comprising:
combining said predictions of class probabilities of said artificial neural network and said classification model as a log sum of corresponding class probabilities using a residual connection.

4. The method as recited in claim 1, wherein a categorical cross entropy loss corresponds to a distance between ground truth labels and said combined predictions of class probabilities of said artificial neural network and said classification model.

5. The method as recited in claim 1, wherein a categorical cross entropy loss corresponds to a distance between said prediction of class probabilities of said second model and said combined predictions of class probabilities of said artificial neural network and said classification model.

6. The method as recited in claim 1, wherein a categorical cross entropy loss corresponds to a sum of a top-k probability weighted log probabilities, where k is a positive integer number.

7. The method as recited in claim 1, wherein said machine learning model is a deep learning model.

8. A computer program product for training a machine learning model using noisily labeled data, the computer program product comprising one or more computer readable storage mediums having program code embodied therewith, the program code comprising programming instructions for:
building a classification model that receives a classified dataset for which classes are pre-labeled as input, wherein said classified dataset comprises label noise, wherein said classification model generates a prediction of class probabilities;
building a second model with a same architecture as said classification model, wherein said second model is a moving average of said classification model, wherein said second model generates a prediction of class probabilities;
generating weight factors used to weight said predictions of class probabilities of said classification model and said second model by an artificial neural network;
obtaining a prediction of class probabilities using said weighted predictions by said artificial neural network; and
combining said predictions of class probabilities of said artificial neural network and said classification model to train said machine learning model.

9. The computer program product as recited in claim 8, wherein the program code further comprises the programming instructions for:
updating parameters of said second model as said moving average of said classification model.

10. The computer program product as recited in claim 8, wherein the program code further comprises the programming instructions for:
combining said predictions of class probabilities of said artificial neural network and said classification model as a log sum of corresponding class probabilities using a residual connection.

11. The computer program product as recited in claim 8, wherein a categorical cross entropy loss corresponds to a distance between ground truth labels and said combined predictions of class probabilities of said artificial neural network and said classification model.

12. The computer program product as recited in claim 8, wherein a categorical cross entropy loss corresponds to a distance between said prediction of class probabilities of said second model and said combined predictions of class probabilities of said artificial neural network and said classification model.

13. The computer program product as recited in claim 8, wherein a categorical cross entropy loss corresponds to a sum of a top-k probability weighted log probabilities, where k is a positive integer number.

14. The computer program product as recited in claim 8, wherein said machine learning model is a deep learning model.

15. A system, comprising:
a memory for storing a computer program for training a machine learning model using noisily labeled data; and
a processor connected to said memory, wherein said processor is configured to execute program instructions of the computer program comprising:
building a classification model that receives a classified dataset for which classes are pre-labeled as input, wherein said classified dataset comprises label noise, wherein said classification model generates a prediction of class probabilities;
building a second model with a same architecture as said classification model, wherein said second model is a moving average of said classification model, wherein said second model generates a prediction of class probabilities;
generating weight factors used to weight said predictions of class probabilities of said classification model and said second model by an artificial neural network;
obtaining a prediction of class probabilities using said weighted predictions by said artificial neural network; and
combining said predictions of class probabilities of said artificial neural network and said classification model to train said machine learning model.

16. The system as recited in claim 15, wherein the program instructions of the computer program further comprise:
updating parameters of said second model as said moving average of said classification model.

17. The system as recited in claim 15, wherein the program instructions of the computer program further comprise:
combining said predictions of class probabilities of said artificial neural network and said classification model as a log sum of corresponding class probabilities using a residual connection.

18. The system as recited in claim 15, wherein a categorical cross entropy loss corresponds to a distance between ground truth labels and said combined predictions of class probabilities of said artificial neural network and said classification model.

19. The system as recited in claim 15, wherein a categorical cross entropy loss corresponds to a distance between said prediction of class probabilities of said second model and said combined predictions of class probabilities of said artificial neural network and said classification model.

20. The system as recited in claim 15, wherein a categorical cross entropy loss corresponds to a sum of a top-k probability weighted log probabilities, where k is a positive integer number.
